(19) United States
(12) Patent Application Publication
(10) Pub. No.: US 2022/0029507 A1
(43) Pub. Date: Jan. 27, 2022

(54) Power Generation using a Paraglider and Motion along the Control Cable

(71) Applicant: Robotic Research, LLC, Gaithersburg, MD (US)

(72) Inventors: Alberto Daniel Lacaze, Potomac, MD (US); Karl Nicholas Murphy, Rockville, MD (US); William Becker, Gaithersburg, MD (US); Steven Rotondo, Gaithersburg, MD (US)

(73) Assignee: Mr. Alberto Daniel Lacaze, Gaithersburg, MD (US)

(21) Appl. No.: 16/938,919

(22) Filed: Jul. 25, 2020

(51) Int. Cl. H02K 7/18; B60L 53/52; B64C 31/06; H02K 7/116; H02K 11/00; H02K 11/20; H02K 11/30; F03D 5/00

(52) U.S. Cl. CPC H02K 7/183; B60L 53/52; B64C 31/06; H02K 7/116; F05B 2220/706; H02K 11/20; H02K 11/30; F03D 5/00; H02K 11/0094

(57) ABSTRACT

In the current invention, the parafoil follows a longitudinal trajectory away or towards the generator. The work is created along the path of the line, not across. When the parafoil is extended away from the vehicle generating power, the parafoil is set by the control system in a high drag configuration. When the parafoil reaches the end of the line (or close to it), the controller sets up the parafoil in the retraction mode. In this mode, the parafoil still creates lift, but, at a significantly lower drag, and therefore, the ground station can easily retrieve it by pulling the line towards the vehicles.

### CROSS-REFERENCES TO OTHER APPLICATIONS

None.

### STATEMENT REGARDING FEDERAL SPONSORSHIP

No part of the invention was a result of a federally sponsored research.

### FIELD OF THE INVENTION

The invention pertains to power generation that is obtained by using a paraglider with motion along the control cable.

### COPYRIGHT AND TRADEMARK NOTICE

A portion of the disclosure of this patent application may contain materials that is subject to copyright protection. The owner has no objection to the facsimile reproduction by anyone of the patent document or the patent disclosure, as it appears in the Patent and trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of the invention to material associated only with such marks.

### BACKGROUND OF THE INVENTION

There are several methods of power generation using wind. Windmills have been used to generate power since ancient times. Although windmills design vary significantly, in its simplest form, one or more rotating airfoils (blades) are used to rotate a shaft that is then used to either generate electrical power or to exert mechanical work of some kind.

Windmills are usually mounted on a column to separate the moving parts from the ground. This has several reasons: Wind speed is usually faster at higher elevations as the ground effects and occlusions lower wind speed. Ground effects create a more turbulent flow that usually negatively affects the efficiency of the airfoil. The rotating airfoils are maintained at a certain height to protect humans or animals from getting hit.

The structures needed to maintain this separation from the ground can cost as much as the active components of the mill. This structure needs to be maintained and needs to withstand all weather conditions to be safe and cost effective.

These large structures make movable energy production cumbersome as the structures that provide sufficient elevation that are strong enough to withstand the torques generated by the foils given the mechanical advantage of the lever arm are neither light nor portable. Therefore, mills often are permanent structures with significant infrastructure costs and maintenance costs that need to be accounted for as part of the power generation costs.

This is one of the reasons why ancient mills are built in mountaintops, to have access to the wind channeled by the topography while minimizing structures needed to elevate the rotating airfoils.

### SUMMARY OF THE INVENTION

Utilizing a parafoil(kite/paraglider) connected through a cable to a ground vehicle provides some advantages for some applications and can create a cost-effective solution for power generation.

There are many advantages as described below:

No column/vertical structure needed to lift the power generation to take advantage of the higher wind speed/less turbulent wind.

Power generation can be easily installed at ground level as opposed to conventional windmills where the transfer of the mechanical energy to the ground usually includes shafts that are not easy to assemble with a portable setup.

Parafoils can be lowered in storms or in conditions that are not favorable for power generation.

Because the infrastructure needed to deploy and harvest energy is significantly smaller, they can easily be deployed from a vehicle.

In the invention, the line on the parafoil is extended and retracted creating a path for the parafoil that is significantly smaller than other systems.

The system is safe to the environment including flying critters.

The energy harvesting per pound of infrastructure can significantly outperform a traditional mill or solar cell since the parafoils, lines, and generators are light and efficient.

Power generation can be performed day or night and can effectively complement a solar array minimizing battery needs.

Power generation can be performed on cloudy days.

Given standards vehicles and common weather conditions, the proposed invention can outperform solar cells installed on a vehicle given that the vehicle roof real estate is always limited and usually not flat or easily directed towards the sun.

### BRIEF DESCRIPTION OF THE DRAWINGS

The present invention is described in the detailed description that follows, with reference to the following noted drawings that illustrate non-limiting examples of embodiments of the present invention, and in which the reference numerals represent similar parts throughout the drawings.

FIG. 1—Figure illustrating the system in a high drag confirmation.

FIG. 2—Figure illustrating the parafoil in the retraction mode.

### DETAILED DESCRIPTION OF THE INVENTION

Elements in the Figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

Unless specifically set forth, the terms “a,” “an,” and “the” are not limited to one element, but instead should be read as meaning “at least one!” The terminology includes the words noted above, derivatives thereof, and words of similar import.

The particulars shown herein are given as examples and are for the purposes of illustrative discussion of the embodiments of the present invention only and are presented in the cause of providing what is believed to be the most useful and readily understood description of the principles and conceptual aspects of the present invention.

Parafoils have been used for power generation in a variety of applications. In most of these inventions, the parafoil is maintained at a constant distance from the power generation and the cross movement of the parafoil is used to create the work that powers the generator. These parafoils are designed to fly in circles or figure eights. The generator is driven by the sideways movement of the cable as the parafoil creates the movement.

The problem with these methods is that the further the parafoil is to the generator, the larger the circles or figure eights that the parafoil needs to generate in order to create an angle large enough to effectively harvest energy.

In the current invention, the parafoil follows a longitudinal trajectory away or towards the generator. The work is created along the path of the line, not across.

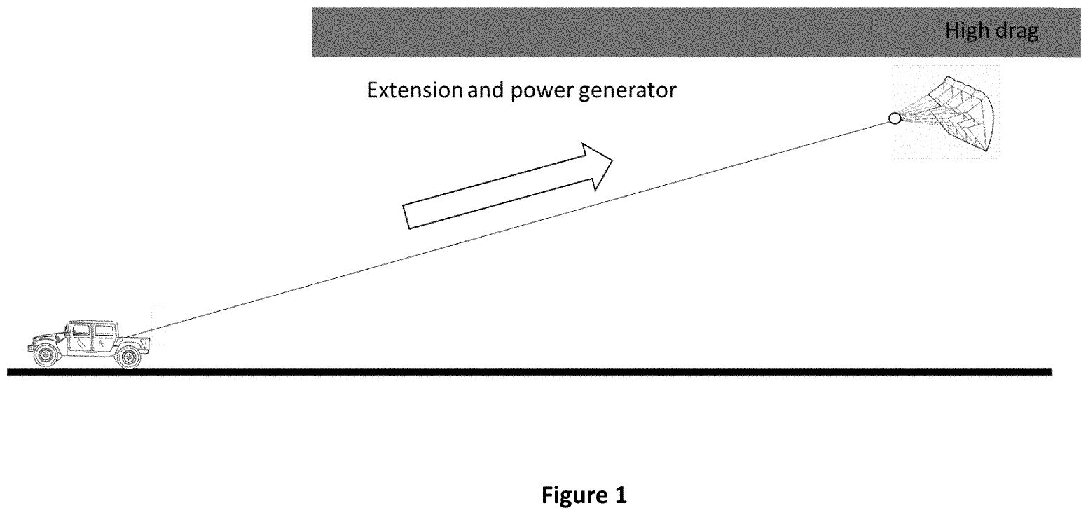

controller changes the shape of the parafoil. When the parafoil is extended away from the vehicle generating power, the parafoil is set by the control system in a high drag configuration as shown in FIG. 1.

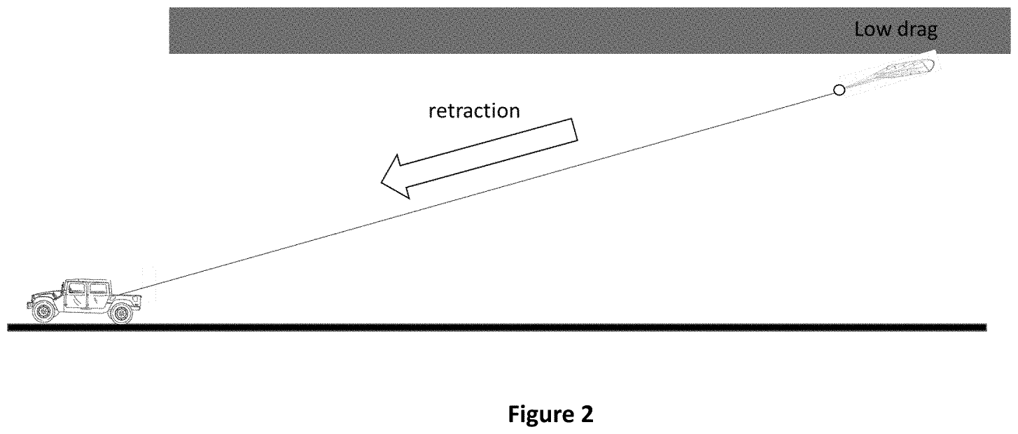

When the parafoil reaches the end of the line (or close to it), the controller sets up the parafoil in the retraction mode. In this mode, the parafoil still creates lift, but, at a significantly lower drag, and therefore, the ground station can easily retrieve it by pulling the line towards the vehicles as shown in FIG. 2.

The energy harvested as the parafoil is extended significantly outweighs the energy necessary for retracting, and therefore the net gain of energy collection is achieved.

In the extension part of the cycle, the generator engages and is driven as the parafoil is dragged by the wind generating energy.

We presented many advantages, however, an important one is that the area needed for operating the system is relatively small in comparison with figure eight or circles configuration where the parafoils need hundreds or thousands of meters to move to generate energy. This is important if multiple parafoils are flown.

The present invention significantly minimizes the operating volume and therefore minimizes parafoil collisions, entanglements, and overall increases the amount of energy that can be harvested by ground area.

The invention describes a system for power generation comprising a generator installed on a ground station (moving or permanent) that generates energy as the parafoil is flying away, a parafoil with control interfaces that changes its shape. At least one shape is used for power generation and at least one shape is used for retrieval and one or more lines connected to the parafoil that release or retract the parafoil and powers the generator.

A parafoil is a nonrigid (textile) airfoil with an aerodynamic cell structure which is inflated by the wind. Ram-air inflation forces the parafoil into a classic wing cross-section. Parafoils are most commonly constructed out of ripstop nylon. Parafoils come in a number of shapes and sizes. These include single line kites to large lifting parasols, to multi-line traction kites designed to generate pull and power for snow kiting and kite surfing. The same theory is used with many large inflatable show kites that you may have seen.

In this system, the generator is used as a motor to retrieve the parafoil in the retraction part of the cycle

In this system, the generator uses different gears to optimize the energy production as the parafoil is in the extension cycle. The system of claim 1 wherein the parafoil has other control surfaces that allows the controller to change the azimuth of the parafoil

The azimuth is an angular measurement in a spherical coordinate system. The vector from an observer to a point of interest is projected perpendicularly onto a reference plane; the angle between the projected vector and a reference vector on the reference plane is called the azimuth.

In the system proposed by the current invention, the controller can compute the catenary created by the line and compute extension/retraction speed to make sure that the line does not touch the ground, or the line stays above certain thresholds.

Catenary is defined as an angular measurement in a spherical coordinate system. The vector from an observer to a point of interest is projected perpendicularly onto a reference plane; the angle between the projected vector and a reference vector on the reference plane is called the azimuth.

In this system, the controller is attached to the line closer to the parafoil or is on the ground closer to the generator.

In this system, the controller has a wind speed sensor and or a wind direction sensor.

In this system, the parafoil has different control surfaces that create different drag for different wind conditions.

In this system, the generator is a dynamo, that can be driven for retraction.

Dynamos and Generators convert mechanical rotation into electric power. Dynamo - a device that makes direct current electric power using electromagnetism. It is also known as a generator; however, the term generator normally refers to an “alternator” which creates alternating current power. Dynamos and Generators convert mechanical rotation into electric power. Dynamo—a device that makes direct current electric power using electromagnetism. It is also known as a generator; however, the term generator normally refers to an “alternator” which creates alternating current power.

In this system, there is a battery that is charged during extension and discharged during retraction. In this system, the communication to the controller is performed using a radio or the line holding of the parafoil. In this system, the controller has sensors that measure occlusions that can hit the line or the parafoil.

In this system, as the line extends it winds a spring that is used to retract the parafoil in the 0etraction part of the cycle.

In this system, the parafoil or the line is also equipped with other sensors (ISR, CBNE, EW, etc.) or a radio that can be used as a relay. ISR refers to Intelligence Surveillance Reconnaissance. CBRE sensors are the chemical, biological, nuclear, and environmental sensors. Electronic Warfare (EW) represents the ability to use the electromagnetic spectrum—signals such as radio, infrared or radar—to sense, protect, and communicate. At the same time, it can be used to deny adversaries the ability to either disrupt or use these signals.

In this system, the parafoil may have inflatable components to maintain its shape. In this system the parafoil may have lighter than air components. In this system, the retraction and contraction speeds are changed if the vehicles are in motion

In this system, the controller can command surfaces to maintain the elevation above a certain altitude. In this system, the controller is capable of measuring the power generation efficiencies and optimize altitude, speed of retraction, and speed of expansion. The system of claim 1 wherein the controller can maximize drag of periods of time to create burst of power. The system of claim 1 wherein the generator is connected to a power converter/filtering/conditioning to create desired voltage/waveform.

The embodiments of the invention in which an exclusive property or privilege is claimed are defined as follows:

1. A system for power generation comprising:
a. A generator installed on a ground station (moving or permanent) that generates energy as the parafoil is flying away.
b. A parafoil with control surfaces that change its shape. At least one shape is used for power generation and at least one shape is used for retrieval.
c. One or more lines connected to the parafoil that release or retract the parafoil and powers the generator.
d. A control system that can change the control surfaces in the parafoil.

2. The system of claim 1 wherein the generator is used as a motor to retrieve the parafoil in the retraction part of the cycle

3. The system of claim 1 wherein the generator is uses different gears to optimize the energy production as the parafoil is in the extension cycle

4. The system of claim 1 wherein the parafoil has other control surfaces that allows the controller to change the azimuth of the parafoil

5. The system of claim 1 wherein the controller can compute the catenary created by the line and compute extension/retraction speed to make sure that the line does not touch the ground, or the line stays above certain thresholds

6. The system of claim 1 wherein the controller is attached to the line closer to the parafoil or is on the ground closer to the generator

7. The system of claim 1 wherein the controller has a wind speed sensor and or a wind direction sensor

8. The system of claim 1 wherein the parafoil has different control surfaces that create different drag for different wind conditions.

9. The system of claim 1 wherein the generator is a dynamo, that can be driven for retraction.

10. The system of claim 1 with the addition of a battery that is charged during extension and discharged during retraction

11. The system of claim 1 wherein the communication to the controller is performed using a radio or the line holding the parafoil.

12. The system of claim 1 wherein the controller has sensors that measure occlusions that can hit the line or the parafoil.

13. The system of claim 1 wherein as the line extends it winds a spring that is used to retract the parafoil in the retraction part of the cycle.

14. The system of claim 1 wherein the parafoil or the line is also equipped with other sensors (ISR, CBNE, EW, etc.) or a radio that can be used as a relay.

15. The system of claim 1 wherein the parafoil may have inflatable components to maintain its shape

16. The system of claim 1 wherein the parafoil may have lighter than air components

17. The system of claim 1 wherein the retraction and contraction speeds are changed if the vehicles are in motion

18. The system of claim 1 wherein the controller can command surfaces to maintain the elevation above a certain altitude

19. The system of claim 1 wherein the controller is capable of measuring the power generation efficiencies and optimize altitude, speed of retraction, speed of expansion.

20. The system of claim 1 wherein the controller can maximize drag of periods of time to create burst of power

21. The system of claim 1 wherein the generator is connected to a power converter/filtering/conditioning to create desired voltage/waveform.
